(19) United States
(12) Patent Application Publication
(10) Pub. No.: US 2023/0250980 A1
(43) Pub. Date: Aug. 10, 2023

(54) AIR BALANCER SYSTEM

(71) Applicant: Yehuda Fulda, Beit Shemesh (IL)

(72) Inventor: Yehuda Fulda, Beit Shemesh (IL)

(21) Appl. No.: 18/133,814

(22) Filed: Apr. 12, 2023

Related U.S. Application Data
(60) Provisional application No. 63/330,804, filed on Apr. 14, 2022.

(51) Int. Cl. F24F 11/00; F24F 11/77

(52) U.S. Cl. CPC F24F 11/0001; F24F 11/77; F24F 2011/0002

(57) ABSTRACT

The present invention provides a system and method for balancing airflow or air pressure within a living space/room. The air balancer system includes a Room Air Balancer Trigger Module (RABTM) in communication with an ERV or HRV control module. The ERV or HRV control module is adapted for use with an ERV or HRV unit and the RABTM is configured to be used with an air exhausting facility of an attached facility such as a bathroom located in the living space or in the vicinity of the living space to ensure any negative air pressure created within the room or living space at any point of time is equally compensated to achieve balanced air pressure and quality within the room or living space.

### CROSS-REFERENCE TO RELATED PATENT DOCUMENTS

This patent application claims the benefit of priority of U.S. Provisional Application No. 63/330,804 entitled “AIR BALANCER SYSTEM,” filed 14 Apr. 2022, which is hereby incorporated herein by reference in its entirety.

### TECHNICAL FIELD

This invention relates generally to the field of ventilation and particularly to the ventilation of residential and commercial living spaces relying upon energy recovery ventilators (ERVs) and/or heat recovery ventilators (HRVs). Particularly, the present invention relates to an air ventilation control system or an air balancer system adapted for use with the air exhausting facility (Eg. exhaust fans) of the bathrooms (or any other similar places such as a kitchen) and ERVs or HRVs configured in a tightly insulated room/living space of a building in order to ensure any negative air pressure created within the room/living space at any point of time is equally compensated to achieve balanced air pressure within the room/space.

### BACKGROUND

Fresh and balanced air is needed for the comfort and health of occupants living in a room/living space. Up until the last few decades, houses were made leaky to air that, enabled sufficient air to seep in to meet the needs of occupants and ensure homes had all needed air inside in a balanced condition. These houses were said to ‘breathe’. Nowadays, in the name of energy efficiency, houses are being built to much higher standards of air tightness which require mechanical ventilation systems (HRVs or ERVs) to maintain healthy and sufficient indoor air.

Usually, the modern living spaces/rooms include HRV or ERV. Typically, Heat Recovery Ventilation (HRV) is a system that utilizes the heat in old external air to preheat entering new air. It decreases the energy needed to bring up outside air to the room temperature so preserves money on heating costs and bills. Energy Recovery Ventilation (ERV) is more complex than the HRV, as this model also catches some of the moisture in the air. Therefore, in cold winter climates, an ERV system moves the moisture from the exhausted air to the entering new and dry air to help maintain the indoor moisture rate at a reasonable value.

Further, the modern living spaces/rooms include an attached bathroom with an exhausting facility configured therein. The air-exhausting facility is usually installed on a ceiling panel inside the bathroom, and a fan is provided on the top or a side of the facility for smooth exhaust of the air. The air-exhausting system draws the moisture or odor or air out of the bathroom. In conditions, where the bathrooms are not airtight or leaky, the air-exhausting facility will suck a certain amount of air from the living room/space thereby creating a negative pressure inside the living room. Usually, as a thumb rule, for proper ventilation within a space, an air intake should be the same as the amount of air exhaust to retain air balance. If the bathroom's air exhausting facility or fan is exhausting say, for example, 100 CFM of air at an instant of time by sucking air present in the living room, and the ERV/HRV system is capable of intaking 100 CFM and exhausting 100 CFM at the same instant of time. The resultant air pressure created within the living space at that instant of time would go negative (−100 CFM), rendering ventilation difficult which is undesirable and would eventually affect the occupant's health.

In the light of the aforementioned background, it is desirable to have an air ventilation control system or an air balancer system that could be used with the air exhausting facility (Eg. exhaust fans) of the bathrooms (or any other similar places such as kitchens) and ERVs or HRVs units installed in the living spaces to ensure any negative air pressure created within the room/living space at any instant of time is equally compensated to achieve a balanced air pressure and quality.

### BRIEF SUMMARY

The present invention has been designed to address the above issue, with an object to provide a simple and easy-to-use air balancer system consisting of an ERV or HRV control module, and a Room Air Balancer Trigger Module (RABTM). The ERV or HRV control module is interfaced or operationally connected with the existing ERV/HRV system of any living space/room or building. The RABTM is configured to interface or operationally connected with an air exhausting facility (Eg. an exhaust fan of a bathroom). The ERV or HRV control module and the RABTM are communicatively linked (using wired or wireless medium) in order to control the speed of the outside air intake fan of the ERV/HRV to compensate for any negative air pressure/airflow created within the living space due to the operation of the air exhausting facility or bathroom's exhaust fan.

During the operation of the air balancer system, the existing HRV and/or ERV unit can reliably maintain a balanced airflow or air pressure between the fresh air and the exhaust air within the living space/room irrespective of the operation of the bathroom air exhausting facility. The air balancer system ensures at any instant of time, the airflow balance within the room/living space is perfectly balanced which would otherwise turn negative in the presence of an operational bathroom exhaust fan.

The present air balancer system is an automated system to control any negative airflow or air pressure created within any living space/room or building (due to the operation of the bathroom fan located in the vicinity of the living space) without requiring any kind of manual measurement. The proposed balancer system would provide a balanced airflow/air pressure under all conditions regardless of the speed of the bathroom's exhaust fan.

According to an embodiment, an air balancer system includes an ERV or HRV control module operationally coupled to and adapted for use with an ERV or HRV unit configured in a room or living space, wherein the ERV or HRV control module is adapted to control an outside air intake fan of the ERV or HRV unit.

According to the embodiment, the air balancer system further includes a Room Air Balancer Trigger Module (RABTM) operationally coupled to and adapted for use with an air exhausting facility of an attached facility present in the room or living space, the RABTM is adapted for continually monitoring a fan's speed in the air exhausting facility and operating mode of the air exhausting facility. The attached facility present in the room or living space is at least a bathroom or a kitchen. The air exhausting facility is an exhaust fan installed in the bathroom or a chimney or kitchen hood installed in the kitchen. The RABTM comprises one or more sensors adapted for monitoring and/or detecting a fan's speed in the air exhausting facility, and operating mode of the air exhausting facility. The operating mode of the air exhausting facility detected by the one or more sensors is at least an activation mode (ON state) or a deactivation mode (OFF state)

According to the embodiment, the RABTM is communicatively linked to the ERV or HRV control module to continually communicate the fan's speed in the air exhausting facility, and/or the operating mode of the air exhausting facility to the ERV or HRV control module so as to control the speed of the outside air intake fan of the ERV/HRV unit to create a balanced airflow within the room or living space irrespective of the fan's speed in the air exhausting facility, and operating mode of the air exhausting facility. The operation of the RABTM and ERV or HRV control module ensures any negative air pressure created within the room or living space at any point in time is equally compensated to achieve balanced air pressure and quality within the room or living space.

According to the embodiment, upon detecting the activation mode, a controller/microprocessor of the RABTM relays a message to the ERV or HRV control module to speed up the outside air intake fan of the ERV or HRV unit in order to compensate for the airflow entering the attached facility from the room or living space. Upon detecting the deactivation mode, the controller/microprocessor of the RABTM relays a message to the ERV or HRV control module to slow down the outside air intake fan of the ERV or HRV unit (102) because during this point the fan of the air exhausting facility is not intaking any air from the living space or room. Further, upon monitoring and detecting the fan's speed in the air exhausting facility by the one or more sensors, the controller/microprocessor of the RABTM communicates with the microprocessor/microcontroller of the ERV or HRV control module for controlling the speed of the outside air intake fan to maintain the airflow balanced within the room or living space.

Various advantages and features of the present invention are described herein with specificity so as to make the present invention understandable to one of ordinary skill in the art, both with respect to how to practice the present invention and how to make the present invention.

### BRIEF DESCRIPTION OF THE DRAWINGS

The above set forth and other features of the present invention are made more apparent in the ensuing description of the preferred embodiments when read in conjunction with the attached drawings, wherein:

FIG. 1 shows a prior art system diagram for a living space/room with an ERV or an HRV and a bathroom exhaust fan system configured in a bathroom attached to the living space.

FIG. 2 shows a system diagram with a proposed air balancer system connected to ERV or HRV and a bathroom fan of FIG. 1, according to an exemplary embodiment.

FIG. 3 illustrates a block diagram representation of the air balancer system in accordance with an embodiment of the disclosure.

### DETAILED DESCRIPTION

Certain terminology is used in the following description for reference only and is not limiting. Unless specifically set forth herein, the terms “a,” “an,” and “the” are not limited to one element, but instead should be read as meaning “at least one.” The terminology includes the words noted above, derivatives thereof, and words of similar import. Before describing the present invention in detail, it should be observed that the present invention utilizes a combination of components, which constitutes an air ventilation control system or an air balancer system adapted for use with the air exhausting facility (Eg. exhaust fans) of the bathrooms and ERVs or HRVs configured in a tightly insulated room/living space. Accordingly, the components have been represented, showing only specific details that are pertinent for an understanding of the present invention so as not to obscure the disclosure with details that may be readily apparent to those with ordinary skill in the art having the benefit of the description herein. As required, the detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

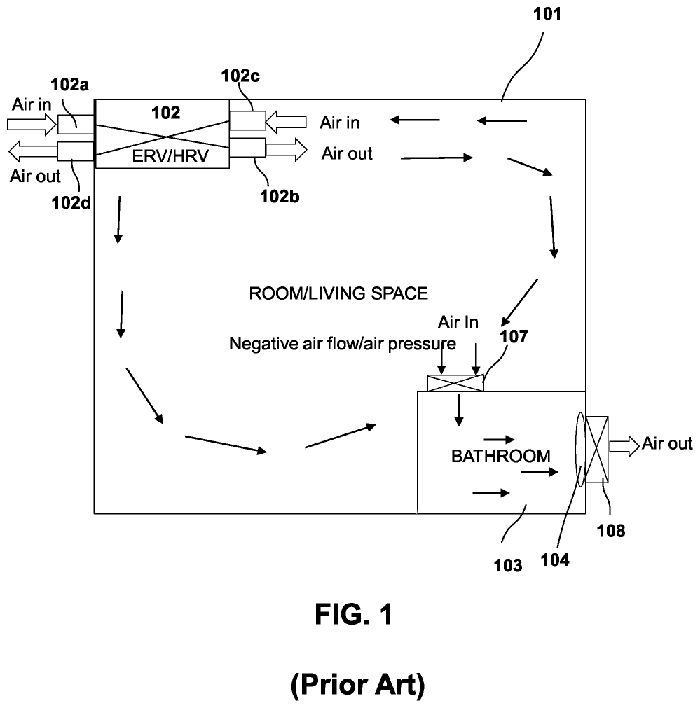

Referring to FIG. 1, a prior art system diagram (a top view) for a living space/room 101 with an ERV or an HRV unit 102 and a bathroom exhaust fan system 104 configured in a bathroom 103 attached to the living space 101 is shown. As used herein, in the present specification the terms building, living space, room, etc relates to any structure that requires fresh air turnover. Thus, the term “living space” comprehends single or multiple-family dwellings such as houses, duplexes, apartments in high-rise buildings, and any other enclosed living or occupation space that requires an inflow of fresh air and an exhaust of stale air to meet the needs of living breathing occupants. The ERV/HRV unit 102 is shown installed near the ceiling area of room 101. As known, any ERV/HRV unit 102 includes a core (not seen), inlets 102a, 102c, outlets 102b, 102d. Stale air passes through inlet 102c into the core. Once through the core it is passed to an exhaust outlet 102d. Fresh air enters the unit 102 through fresh air inlet 102a, and passes through the core. Fresh air is exhausted from the unit 102 through fresh air outlet 102b and then reaches the room 101. In an embodiment of the present invention, two separate variable speed blowers/fans may be provided within the ERV/HRV unit 102, one for the fresh air flow through (referred to as “outside air intake fan”) and the other for the exhaust air flow through the unit 102 (referred to as “inside air exhaust fan). During the normal course of operation, the amount of fresh air entering the room/living space 101 is equated with the amount of air exhausted by the inside air exhaust fan. Thus, always keeping the airflow or air pressure within the room 101 balanced. But in scenarios, where some attached bathroom 103 is located within room 101, then it is possible the air exhausting facility (Eg. exhaust fan 104) of the bathroom 103 may suck in some of the air present in the room (through the vents/leaky space 107) for exhausting the air out of the bathroom 103 through the vent 108. The operation of the air exhausting facility 104 of the bathroom 103 creates an undue burden on the air pressure within the living space/room 101 creating a negative pressure. For example, if the ERV/HRV unit 102 is capable of taking in 100 cubic feet per minute (CFM) ventilation value at an instant of time and capable of exhausting 100 cubic feet per minute (CFM) at the same instant of time. At the same time, the bathroom air exhausting facility 104 is capable of taking in (sucking) 100 CFM ventilation value for exhausting the 100 CFM ventilation value out of bathroom 103 then the resultant pressure created within the living space/room 101 would be −100 CFM when bathroom fan's and ERV/HRV unit both are operational, which is undesirable.

Thus, inventor herein has come up with a novel solution in the form of an air balancer system adapted for use with the air exhausting facility (Eg. exhaust fan) of the bathroom 103 and ERV or HRV unit 102 installed in the room 101 that would provide a balanced airflow/air pressure under all conditions inside the living space 101 regardless of the speed of the bathroom's exhaust fan 104 or turning on/off of the exhaust fan 104 of the bathroom 103.

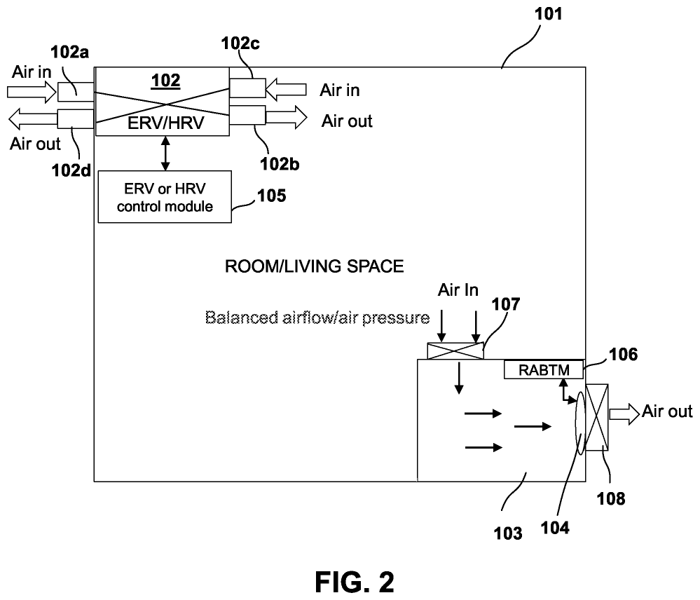

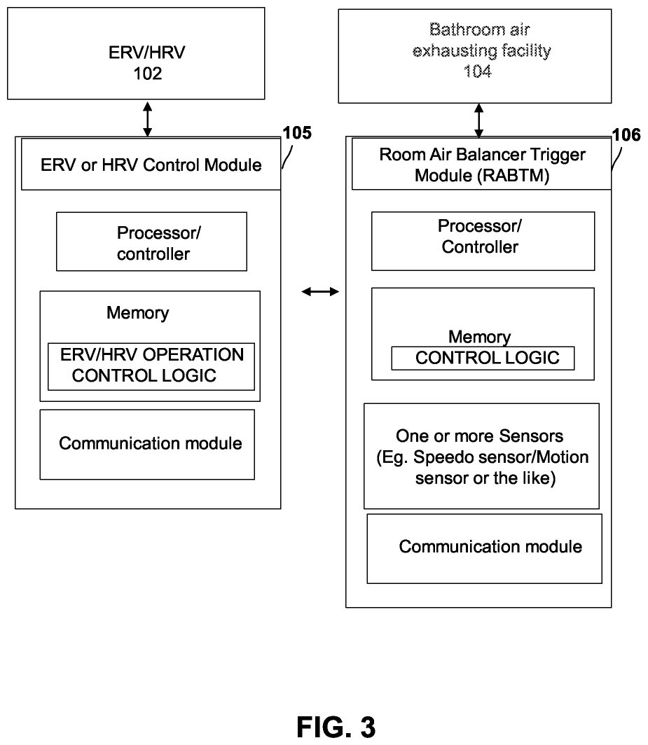

The component level configuration of the air balancer system will be described in detail below in conjunction with FIGS. 2 and 3. As seen, FIG. 2 shows an exemplary installation of the air balancer system with the existing ERV/HRV unit 102 and the bathroom's exhaust fan 104. Particularly, the air balancer system includes an ERV or HRV control module 105 operationally coupled to or installed in the vicinity of the ERV/HRV unit 102. The air balancer system also includes a Room Air Balancer Trigger Module (RABTM) 106 configured or operationally coupled to or installed near the vicinity of an air exhausting facility 104 of an attached facility 103 of a room/living space 101. For the purpose of this application, the attached facility 103 herein is referred to as a bathroom having an exhaust fan 104, however, it may be any other attached facility such as a kitchen with a kitchen hood. Thus, although the RABTM 106 is shown installed with the air exhausting facility 104 in the bathroom, it should be understood that the ERV or HRV control module 105 is communicatively linked to the RABTM 106. RABTM 106 may be connected to any other air exhausting facility at any other place such as the kitchen using a wired or wireless connection. Any suitable wireless connection, for example, the internet (WiFi), cellular communication, Bluetooth, etc may be used.

As seen in FIG. 3, the RABTM 106 is communicatively connected to the bathroom's exhaust fan 104. RABTM 106 preferably includes at least one microprocessor/microcontroller, a memory, one or more sensors, and a communication module (E.g., Bluetooth, Wifi, etc). The memory is any known memory type in the art capable of storing programmed instructions in the form of control logic that defines the operation of the microprocessor/microcontroller. One or more sensors are preferably but not limited to a sensor for sensing fan's speed, or sensing fan's motion. The sensor(s) is configured to detect the operating modes and/or speed of the bathroom's exhaust fan 104 and communicate the same to the microprocessor/microcontroller. Likewise, the ERV or HRV control module 105 is communicatively connected to the ERV/HRV unit 102 in order to control the outside air intake fan of the ERV/HRV unit 102. The ERV or HRV control module 105 also includes at least one microprocessor/microcontroller, a memory having stored therein ERV/HRV operation control logic, and a communication module (Eg. Bluetooth, Wifi, etc). The microprocessors/microcontrollers, communication modules, memory type for ERV or HRV control module 105, and the RABTM 106 may be identical or dissimilar and one can use such components depending upon the requirement.

In operation, depending upon the sensed signal/data by one or more sensors, the microprocessor/microcontroller executes the programmed control logic and sends out a signal to the ERV or HRV control module 105 located at the ERV/HRV unit 102. Upon receiving the signal from the RABTM 106, the processor of the ERV or HRV control module 105 executes ERV/HRV operation control logic and prompts or controls the outside air intake fan (not seen) of the ERV/HRV unit 102 to adjust the speed in order to create a balanced airflow within the living space 101 irrespective of the operation of the bathroom's fan 104.

In an example scenario, the sensor(s) of the RABTM 106 may sense an activation mode or state (Turn on mode) of the bathroom's fan 104, and the controller will then, based on this sensed data send out or relay a message to the ERV or HRV control module 105 to speed up the outside air intake fan (of ERV/HRV unit 102) in order to compensate for the airflow that enters the bathroom 103 from the room 101 due to operating exhaust fan 104 of the bathroom 103. Likewise, if the sensor(s) sense a deactivation mode or state (Turn OFF mode) of the bathroom's fan 104, the controller will then based on this sensed data send out or relay a message to the ERV or HRV control module 105 to slow down the speed of the outside air intake fan (or bring the speed of the outside air intake fan to normal) because at this point the bathroom's fan 104 won't be intaking any air from the living space/room 101. Not only this, the sensor(s) may be able to detect the varying speed of the bathroom's fan 104 and/or CFM ventilation value in the bathroom 103 and accordingly communicate with the microprocessor/microcontroller of the RABTM 106 to relay a message to the microprocessor/microcontroller of the ERV or HRV control module 105 for controlling the speed of the outside air intake fan accordingly so that CFM ventilation value in the room/living space 101 remain balanced.

Although the air balancer system 105, 106 has been described above as retrofitting modules that may be connected to the existing ERV/HRV units, or existing bathroom fan, it is possible that the provided solution be made an integral part of the ERV/HRV units and bathroom's fan. Also, it is possible that the existing ERV/HRV unit 102 is connected to an HVAC system configured in a building or living space. The presented solution can be implemented in such scenarios as well in a similar manner as described above.

Further, it should be understood by those skilled in the art that the exhaust fan can be a bathroom exhaust fan 104 as described above or it could be a kitchen exhaust or a kitchen range hood and any other exhaust unit. The air balancer system particularly, RABTM 106 may be connected to any device capable of drawing air out of the room/living space. Thus, the use of the RABTM 106 should not be construed as limited to just the bathroom exhaust.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

What is claimed is:

1. An air balancer system, comprising:
an ERV or HRV control module (105) operationally coupled to and adapted for use with an ERV or HRV unit (102) configured in a room or living space (101), wherein the ERV or HRV control module (105) is adapted to control an outside air intake fan of the ERV or HRV unit (102);
a Room Air Balancer Trigger Module (RABTM) (106) operationally coupled to and adapted for use with an air exhausting facility (104) of an attached facility (103) present in the room or living space (101), the RABTM (106) is adapted for continually monitoring a fan's speed in the air exhausting facility (104), and operating mode of the air exhausting facility (104);
wherein, the RABTM (106) is communicatively linked to the ERV or HRV control module (105) to continually communicate the fan's speed in the air exhausting facility (104), and/or the operating mode of the air exhausting facility (104) to the ERV or HRV control module (105) so as to control the speed of the outside air intake fan of the ERV/HRV unit (102) to create a balanced airflow within the room or living space (101) irrespective of the fan's speed in the air exhausting facility (104), and operating mode of the air exhausting facility (104); and
wherein the operation of the RABTM (106) and ERV or HRV control module (105) ensures any negative air pressure created within the room or living space (101) at any point in time is equally compensated to achieve balanced air pressure and quality within the room or living space (101).

2. The air balancer system of claim 1, wherein the attached facility (103) present in the room or living space (101) is at least a bathroom or a kitchen.

3. The air balancer system of claim 1, wherein the air exhausting facility (104) is an exhaust fan installed in the bathroom (103) or a chimney or kitchen hood installed in the kitchen.

4. The air balancer system of claim 1, wherein the RABTM (106) comprises one or more sensors adapted for monitoring and/or detecting a fan's speed in the air exhausting facility (104), and operating mode of the air exhausting facility (104).

5. The air balancer system of claim 4, wherein the operating mode of the air exhausting facility (104) detected by the one or more sensors is at least an activation mode (ON state) or a deactivation mode (OFF state)

6. The air balancer system of claim 5, wherein upon detecting the activation mode, a controller/microprocessor of the RABTM (106) relays a message to the ERV or HRV control module (105) to speed up the outside air intake fan of the ERV or HRV unit (102) in order to compensate for the airflow entering the attached facility (103) from the room or living space (101).

7. The air balancer system of claim 5, wherein upon detecting the deactivation mode, the controller/microprocessor of the RABTM (106) relays a message to the ERV or HRV control module (105) to slow down the outside air intake fan of the ERV or HRV unit (102) because during this point the fan of the air exhausting facility (104) is not intaking any air from the living space or room (101).

8. The air balancer system of claim 5, wherein, upon monitoring and detecting the fan's speed in the air exhausting facility (104) by the one or more sensors, the controller/microprocessor of the RABTM (106) communicates with the microprocessor/microcontroller of the ERV or HRV control module (105) for controlling the speed of the outside air intake fan to maintain the airflow balanced within the room or living space (101).
